(19) United States
(12) Patent Application Publication
(10) Pub. No.: US 2021/0266240 A1
(43) Pub. Date: Aug. 26, 2021

(54) EMBEDDED INTRUSION DETECTION SYSTEM ON A CHIPSET OR DEVICE FOR USE IN CONNECTED HARDWARE

(71) Applicant: Johnson Controls Technology Company, Auburn Hills, MI (US)

(72) Inventors: Seán Phillips, Cork (IE); George Silviu Sosiade, Cork (IE); Vincent Hamilton, Cork (IE); Miguel Morillo Iruela, Cork (IE)

(73) Assignee: Johnson Controls Technology Company, Auburn Hills, MI (US)

(21) Appl. No.: 16/799,574

(22) Filed: Feb. 24, 2020

(51) Int. Cl. H04L 12/26; H04L 29/06; H04L 29/08; H04L 12/40

(52) U.S. Cl. CPC H04L 43/062; H04L 12/40; H04L 67/306; H04L 63/1425

(57) ABSTRACT

A device with embedded intrusion detection includes a housing, a first processing circuit configured to perform one or more functions, a communication path configured to communicate data between the first processing circuit and one or more other components, and a second processing circuit. The second processing circuit is configured to monitor the data transmitted on the communication path, determine whether the device is in a compromised state based on the monitored data, and initiate a corrective action responsive to a determination that the device is in the compromised state. The first processing circuit and the second processing circuit are contained within the housing.

### BACKGROUND

The present disclosure relates generally to the field of cybersecurity for building devices. Specifically, the present disclosure relates to detecting cyberattacks on internet-of-things (IoT) systems and devices. As the IoT industry moves towards edge processing and 5G networks, a larger portion of processing may be done locally (i.e., by IoT devices). The evolution and growth of IoT, particularly of IoT enabled devices that handle increased amounts of processing, has created a number of security challenges that may not be properly addressed with traditional cybersecurity techniques. For example, the demand for a comprehensive IoT has led to retrofits of IoT capabilities to existing building devices. Existing building devices that were not designed for IoT or network connections may be at greater risk for cyberattacks, due to the lack of secure boot and runtime security checks or other security measures.

### SUMMARY

One implementation of the present disclosure is a device with embedded intrusion detection. The device includes a housing, a first processing circuit configured to perform one or more functions, a communication path configured to communicate data between the first processing circuit and one or more other components, and a second processing circuit, the first processing circuit and the second processing circuit contained within the housing, the second processing circuit configured to monitor the data transmitted on the communication path, determine whether the device is in a compromised state based on the monitored data, and initiate a corrective action responsive to a determination that the device is in the compromised state.

In some embodiments, the corrective action includes generating a notification including data associated with the determination that the device is in a compromised state, and transmitting, to a user device via a network connection, the notification.

In some embodiments, the corrective action includes at least one of transmitting, via the communication path, a reset signal to the first processing circuit, or transmitting, via the communication path, random data to the first processing circuit.

In some embodiments, the second processing circuit is configured to identify a traffic pattern for the communication path, where the traffic pattern is a pattern of the data transmitted on the communication path, and generate a first traffic profile for the device based on the traffic pattern.

In some embodiments, the second processing circuit is configured to receive a second traffic profile based on previously identified patterns of data associated with known malicious data.

In some embodiments, the second processing circuit is configured to determine that the device is in a compromised state by determining that the monitored data does not match the first traffic profile for the device, or determining that the monitored data is outside of a threshold of the second traffic profile.

Another implementation of the present disclosure is a circuit for detecting whether a building device is in a compromised state. The circuit is structured to be mounted within a housing of the building device, the building device including a processor and a communication path configured to communicate data between the processor and one or more other components of the building device, the circuit including an interface configured to receive data transmitted on the processor communication path, and processing circuitry configured to analyze the received data to determine whether the building device is in a compromised state, and initiate a corrective action responsive to a determination that the building device is in the compromised state.

In some embodiments, the communication path is at least one of an address bus, a data bus, or a control bus.

In some embodiments, the processing circuitry is configured to identify a traffic pattern for the communication path, where the traffic pattern is a pattern of the data transmitted on the communication path, and generate a first traffic profile for the building device based on the traffic pattern.

In some embodiments, the processing circuitry is configured to receive, from the user device, a second traffic profile based on previously identified patterns of data associated with known malicious data.

In some embodiments, a determination that the device is in a compromised state is based on an indication that the analyzed data does not match the first traffic profile for the device, or an indication that the analyzed data is outside of a threshold of the second traffic profile.

In some embodiments, initiating the corrective action includes at least one of transmitting, via the communication path, a reset signal to the processor of the building device, or transmitting, via the communication path, random data to the processor of the building device.

In some embodiments, the processing circuitry is configured to generate, based on a determination that the device is in a compromised state, at least one of an alert or a report, the report including data associated with the determination that the device is in a compromised state, and transmit, to a user device via a network connection, at least one of the alert or the report.

Yet another implementation of the present disclosure is a system. The system includes a building device. The building device includes a housing and a circuit. The circuit includes a processor configured to perform one or more functions, and a communication path configured to communicate data between the processor and one or more other components of the building, where the processor and the communication path are contained within the housing, and an interface configured to receive data transmitted on the communication path, and processing circuitry configured to analyze the received data to determine whether the building device is in a compromised state.

In some embodiments, the processing circuitry is further configured to identify a traffic pattern for the communication path, where the traffic pattern is a pattern of the data transmitted on the communication path, and generate a traffic profile for the building device based on the traffic pattern.

In some embodiments, the processing circuitry is further configured to receive, from the user device, a second traffic profile based on previously identified patterns of data associated with known malicious data.

In some embodiments, a determination that the device is in a compromised state is based on an indication that the analyzed data does not match the first traffic profile for the device, or an indication that the analyzed data matches the second traffic profile.

In some embodiments, the processing circuitry is further configured to initiate a corrective action, where the corrective action includes at least one of transmitting, via the communication path, a reset signal to the processor of the building device, or transmitting, via the communication path, random data to the processor of the building device.

In some embodiments, the processing circuitry is further configured to generate, based on a determination that the device is in a compromised state, at least one of an alert or a report, the report including data associated with the determination that the device is in a compromised state, and transmit, to a user device via a network connection, at least one of the alert or the report.

In some embodiments, the communication path is at least one of an address bus, a data bus, or a control bus.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a perspective view schematic drawing of a server room with building devices that include an embedded intrusion detection system (EIDS), according to some embodiments.

FIG. 2 is a block diagram of an EIDS, according to some embodiments

FIG. 3 is a block diagram of the EIDS of FIG. 2 communicably coupled to an external communication bus of a building device, according to some embodiments.

FIG. 4 is a block diagram of the EIDS of FIG. 2 communicably coupled to an internal communication bus of a building device, according to some embodiments.

FIG. 5 is a flow diagram illustrating a process for detecting cyberattacks on a building device, according to some embodiments.

### DETAILED DESCRIPTION

### Overview

Referring generally to the FIGURES, an intrusion detection system (IDS) for dynamically detecting and responding to cyberattacks on internet-of-things (IoT) enabled devices is shown, according to various embodiments. The IDS may be implemented as an embedded intrusion detection system (EIDS) that can be included on a dedicated chipset for retrofitting to existing building devices or IoT devices. The EIDS may improve low-level security of existing building devices or IoT devices by enforcing secure boot for low-end devices that do not provide support for hardware root of trust (RoT), adding an extra security layer for devices that inaccurately claim to provide secure boot of runtime integrity checks, and reducing the complexity of integrating security measures into existing (i.e., legacy) building and/or IoT devices.

Building with Building Devices

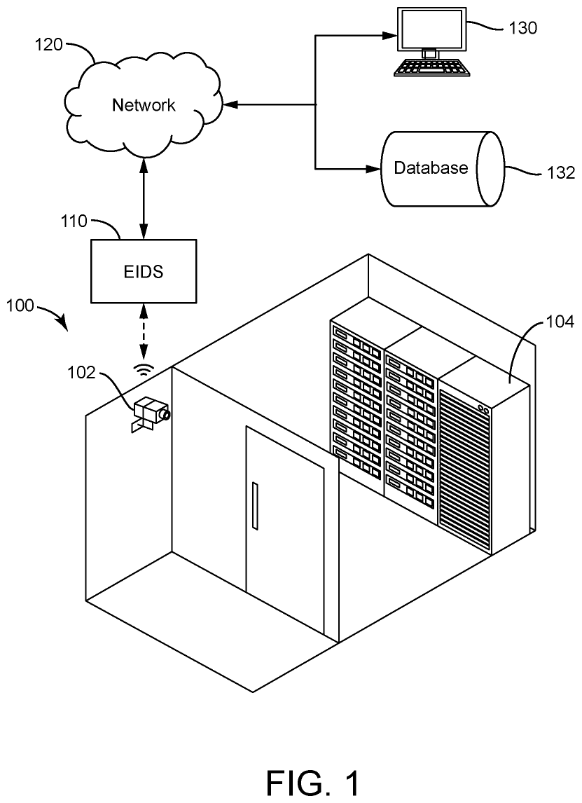

Referring to FIG. 1, a perspective view schematic drawing of a space 100 within a building including one or more building devices that include an embedded intrusion detection system (EIDS) 110 is shown, according to some embodiments. Generally, a building or campus may include a plurality of spaces (e.g., space 100) that include one or more rooms, hallways, floors, etc. Each space may include a plurality of building devices such as HVAC devices, security devices, lighting devices, etc. In some embodiments, one or more of the building devices within each space may include IoT functionality. Space 100 may be an example of such a space within a building that includes a plurality of IoT enabled building devices.

As shown, space 100 may include a server room within a building that houses one or more servers 104. Space 100 is also shown to include a first building device, security camera 102, which may operate to provide video surveillance of at least a portion of space 100. As shown in FIG. 1, for example, security camera 102 may provide video surveillance of a door within space 100, to monitor access to servers 104. In some embodiments, space 100 may include additional building devices such as an access control device (e.g., a card reader, an RFID reader, a keypad, etc.), additional security cameras, alarm devices, HVAC devices (e.g., a thermostat), or other building devices.

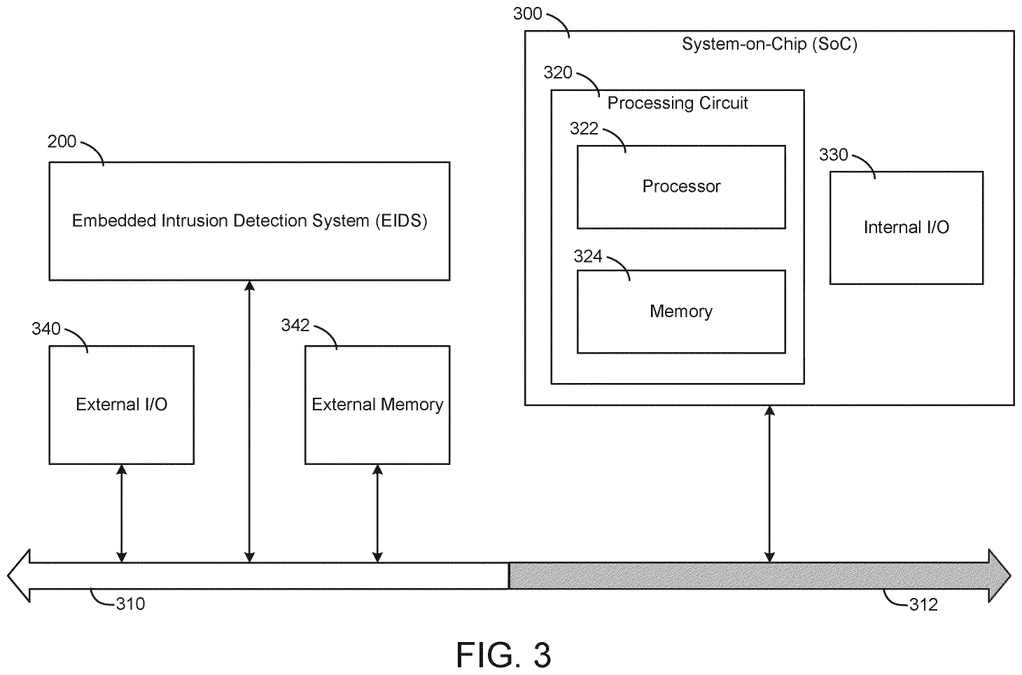

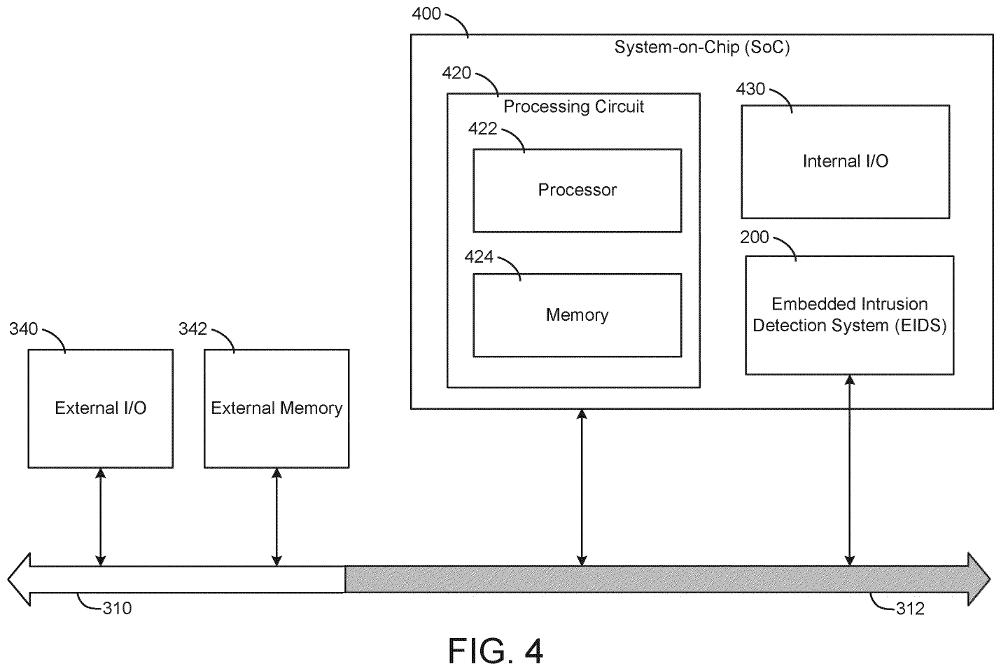

Security camera 102 may include a system-on-chip (SoC) (i.e., a processing circuit or central processing unit (CPU)) that enables the functionality of security camera 102. The SoC may include internal flash memory, random-access memory (RAM), inputs/outputs (I/O's), a cache, and a processor, for example. In some embodiments, EIDS 110 is communicably coupled to one or more external or internal communication busses of the SoC of security camera 102. For example, EIDS 110 may be a standalone (i.e., external) chipset or may be integrated within the SoC of security camera 102, as described in further detail below with respect to FIGS. 3 and 4, respectively. In some embodiments, EIDS 110 is incorporated in the housing of security camera 102.

EIDS 110 is shown to communicate via a network 120. In various embodiments, communications via network 120 may be direct (e.g., local wired or wireless communications) or via a communications network (e.g., a WAN, the Internet, a cellular network, etc.). For example, EIDS 110 may send and/or receive data via an Ethernet-based communications link or network, or a WiFi network. Network 120 may include one or more network engines, servers, cloud services, databases, or other components that operate to store, analyze, and transmit data from/to EIDS 110, a user device 130, and/or a database 132. In some embodiments, network 120 is a network of a building management system (BMS) or a building automation system (BAS).

User device 130 may be can include one or more human-machine interfaces or user interfaces (e.g., graphical user interfaces, reporting interfaces, text-based computer interfaces, client-facing web services, web servers that provide pages to web clients, etc.) for controlling, viewing, or otherwise interacting with EIDS 110. User device 130 can be a computer workstation, a client terminal, a remote or local interface, or any other type of user interface device. User device 130 can be a stationary terminal or a mobile device. For example, user device 130 can be a desktop computer, a computer server with a user interface, a laptop computer, a tablet, a smartphone, a PDA, or any other type of mobile or non-mobile device. User device 130 can communicate with EIDS 110 via network 120.

As described below in further detail, EIDS 110 may monitor data transmitted on the communication busses within security camera 102. When an attempt is made to attack the firmware of security camera 102, EIDS 110 may detect anomalous activity on the communication busses and determine that security camera 102 is being subject to a cyberattack. EIDS 110 may trigger an operation to safeguard security camera 102 by halting the execution of the device's firmware and subsequently transmit an alert and/or a report to network 120. The alert may be an indication that security camera 102 is being attacked, while the report may include information about the attack (e.g., a time the anomalous activity was detected, the data that triggered the alert, the operations initiated by EIDS 110 to safeguard the device, etc.). The alert and/or report, along with any additional data about the attack, may be presented to a user via user device 130 and/or stored within database 132.

### Embedded Intrusion Detection System

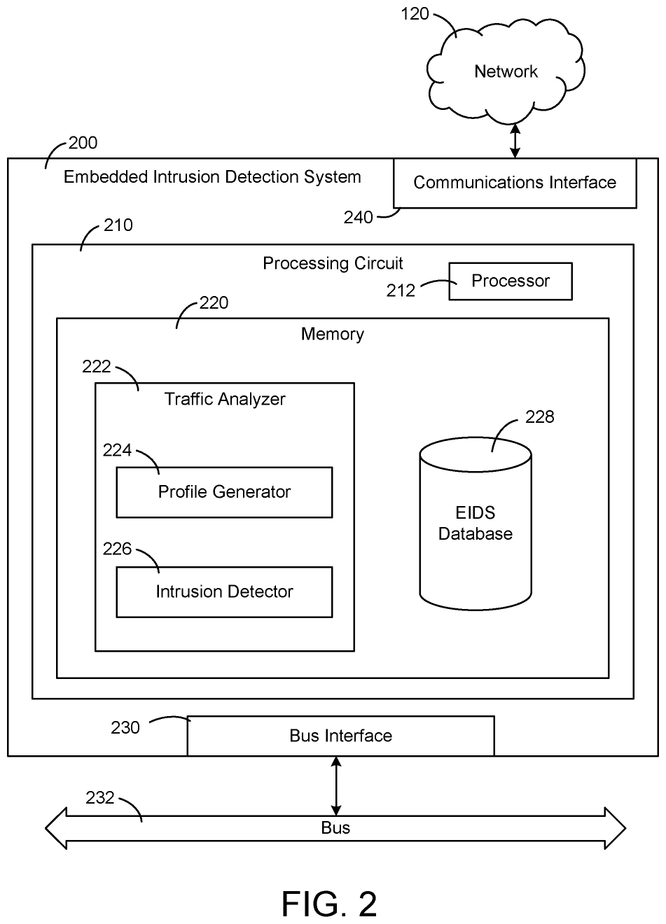

Referring now to FIG. 2, a block diagram of an EIDS 200 is shown, according to some embodiments. In some embodiments, EIDS 200 as shown in FIG. 2 may be a detailed representation of EIDS 110, as described with respect to FIG. 1. EIDS 200 can be configured to monitor one or more buses (i.e., communication paths) within a host device (e.g., an IoT enable building device) and detect attacks to the host device's firmware by identifying anomalies in the data transmitted on said buses. EIDS 200 may be further configured to provide alerts and reports based on anomalous activity to a user via a network connection. EIDS 200 may safeguard the host device against cyberattacks by halting the execution of the host device's firmware in response to a cyberattack. EIDS 200 may be a standalone or integrated chipset within a variety of IoT enabled building devices, such as HVAC devices, security devices, lighting devices, etc., and may be included within a housing of an associated building device.

EIDS 200 is shown to include a processing circuit 210 that includes a processor 212 and a memory 220. It will be appreciated that these components can be implemented using a variety of different types and quantities of processors and memory. For example, processor 212 can be implemented as a general purpose processor, an application specific integrated circuit (ASIC), one or more field programmable gate arrays (FPGAs), a group of processing components, or other suitable electronic processing components.

Memory 220 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 220 can be or include volatile memory or non-volatile memory. Memory 220 can include database components, object code components, script components, or any other type of information structure for supporting the various activities and information structures described in the present application. According to an example embodiment, memory 220 is communicably connected to processor 212 via processing circuit 210 and includes computer code for executing (e.g., by processing circuit 210 and/or processor 212) one or more processes described herein.

Memory 220 is also shown to include a traffic analyzer 222 that may be configured to monitor and analyze data received by a bus interface 230. In some embodiments, bus interface 230 may allow EIDS 200 to transmit and receive data from a bus 232 (e.g., communication path). Bus interface 230 may continuously receive data traffic (i.e., signal traffic) on bus 232, thereby allowing traffic analyzer 222 to analyze the received the data in real-time or near real-time, for example. In some embodiments, traffic analyzer 222 analyzes the data received by bus interface 230 by reading the data and segmenting the data into smaller data packets. Traffic analyzer 222 may also identify patterns within the data traffic, as described in greater detail below. In some embodiments, traffic analyzer 222 analyzes the data received by bus interface 230 by continuously reading the data and comparing it to known data traffic patterns.

Traffic analyzer 222 shown to include a profile generator 224 that can be configured to generate a traffic profile based on the data received from bus 232. The traffic profile may indicate patterns in the data traffic received from bus 232, for example. Profile generator 224 may identify data traffic patterns for the host device and generate a traffic profile based on said data traffic patterns. The traffic profile may be a model or other data of known trustworthy data traffic on bus 232. The profile generated by profile generator 224 may be stored in an EIDS database 228, as described in detail below.

Traffic analyzer 222 is also shown to include an intrusion detector 226 that can be configured to detect and address a threat to the host device. The threat may be a cyberattack that attempts to gain unauthorized access to the host device's firmware, for example. In another example, the threat may be a denial-of-service (DoS) attack that attempts to disrupt operations of the host device. When a threat is detected, intrusion detector 226 may determine and initiate a variety of corrective actions based on the threat. In some embodiments, intrusion detector 226 generates an alert and/or a report for the detected threat and presents the alert so that a user may take further corrective actions. In some embodiments, in addition to or in place of generating and presenting the alert and/or report, intrusion detector 226 safeguards the host device by initiating an operation to halt the execution of the host device's firmware, thereby preventing unauthorized access to the host device.

In various embodiments, traffic analyzer 222 may utilize signature-based or anomaly-based detection methods, or any other suitable detection methods. In signature-based detection methods, for example, data traffic is compared to a known malicious traffic pattern (e.g., a specific data or instruction sequence). A match between the data traffic and a known malicious traffic pattern may indicate a cyberattack. In contrast, anomaly-based detection methods may include comparing the monitored data traffic to a previously generated traffic profile. In anomaly-based detection methods, a change in data traffic or an absence of expected data traffic based on the traffic profile may indicate a cyberattack.

In some embodiments, as briefly mentioned above, intrusion detector 226 generates an alert and/or a report based on a detected threat. The alert may be an indication of the threat or attack that contains a limited amount of information related to the detected threat. The report may be a more in-depth indicator of the threat that includes more information that the alert. In either case, intrusion detector 226 may transmit the generated alert or report to user device 130 via network 120. The alert or report may include an indication of the host device being attacked (e.g., a device name, a device address, etc.), an indication of the type of attack, a corrective action taken in response to the attack, or any other information that may aid a user in determining follow up actions in response to the attack. In some embodiments, the alert or report is sent to user device 130 as a notification, an email, a text message, an automated phone call, or by any other method.

In some embodiments, intrusion detector 226 halts the execution of the host device's firmware by transmitting, via bus 232, a reset signal that causes the host device to reset. The reset signal may safeguard the host device by interrupting the execution of the host device's firmware and rebooting the host device. In some embodiments, intrusion detector 226 halts the execution of the host device's firmware by transmitting, via bus 232, a random data sequence. The random data sequence may jam the bus 232, preventing additional data from being transmitted via the bus 232. For example, the random data sequence may prevent the host device data from being retrieved by the cyber attacker and/or may prevent additional data from being transmitted by the cyber attacker to the host device. In some embodiments, the random data sequence overwhelms the host device's SoC and/or CPU, which may not be able to handle large, random data strings. In other embodiments, another method may be utilized to halt the execution of the host device's firmware in response to a cyberattack.

Memory 220 is shown to include EIDS database 228. As described above, EIDS database 228 may be configured to receive and store information from profile generator 224 and/or retrieve information for intrusion detector 226. For example, EIDS database 228 may store one or more profiles indicating data traffic patterns. In some embodiments, EIDS database 228 may store unique identifiers (e.g., known traffic patterns) of known threats. For example, EIDS database 228 may store previously defined byte sequences or other malicious data sequences for known cybersecurity threats. It will be appreciated that EIDS database 228 can be implemented as a single database or multiple separate databases working together. In some embodiments, EIDS database 228 may be at least partially implemented via network 242.

In some embodiments, EIDS 200 may include a communications interface 240 configured to transmit and/or receive data to/from network 120. As described above, network 120 may include one or more network engines, servers, cloud services, or other components that operate to store, analyze, and transmit data from/to EIDS 200, a user device (e.g., user device 130), and/or a database (e.g., database 132). In some embodiments, a user of a user device 130 interacts with EIDS 200 via network 120.

Referring now to FIG. 3, a block diagram of EIDS 200 communicably coupled to an external bus 310 of a building device is shown, according to some embodiments. In some such embodiments, EIDS 200 may be implemented as a standalone chipset or a circuit that is external to a host device's SoC. A SoC, as previously described, is generally an integrated circuit that integrates a number of electronic components (e.g., of a computer) onto a single chip (e.g., a microchip). For example, a SoC may include internal flash memory, random-access memory (RAM), inputs/outputs (I/O's), a cache, a processor, or other electronic components.

As shown in FIG. 3, a SoC 300 is communicably coupled to an internal bus 312 and includes a processing circuit 320 and an internal input/output (I/O) 330. In some embodiments, SoC 300 is communicably coupled to internal bus 312 via internal I/O 330. In some embodiments, internal bus 312 further includes an address bus, a data bus, and/or a control bus, configured to transfer data, signals, or power to one or more other components of SoC 300. Processing circuit 320 is shown to further include a processor 322 and a memory 324. Processor 322 can be implemented as a general purpose processor, an application specific integrated circuit (ASIC), one or more field programmable gate arrays (FPGAs), a group of processing components, or other suitable electronic processing components.

Memory 324 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 324 can be or include volatile memory or non-volatile memory. Memory 324 can include database components, object code components, script components, or any other type of information structure for supporting the various activities and information structures described in the present application. According to an example embodiment, memory 324 is communicably connected to processor 322 via processing circuit 320 and includes computer code for executing (e.g., by processing circuit 320 and/or processor 322) one or more processes described herein.

In some embodiments, EIDS 200 is configured to monitor data traffic on external bus 310. Similar to internal bus 312, external bus 310 may further include an address bus, a data bus, and/or a control bus, configured to transfer data, signals, or power to one or more other components such as an external I/O 340 and/or an external memory 342. In various embodiments, external bus 310 and internal bus 312 are communicably coupled or are portions of a common bus. As described above, EIDS 200 may monitor data traffic on external bus 310 to generate a traffic profile and/or detect cyberattacks (e.g., directed to SoC 300). In response to a cyberattack, EIDS 200 may also transmit data on external bus 310, and thereby internal bus 312, to alert a user of the cyberattack and/or to disable operations of SoC 300.

In addition to EIDS 200, external I/O 340 and external memory 342 are shown communicably coupled to external bus 310. External I/O 340 may be an input/output module or port configured to transmit and received data from/to external devices. For example, external I/O 340 may transmit and receive data from/to a network or another components or chipset of a host device. Much like memory 324, external memory 342 can include one or more devices (e.g., RAM, ROM, Flash memory, hard disk storage, etc.) for storing data and/or computer code for completing or facilitating the various processes, layers and modules described in the present application. External memory 342 can be or include volatile memory or non-volatile memory. External memory 342 can include database components, object code components, script components, or any other type of information structure for supporting the various activities and information structures described in the present application.

Referring now to FIG. 4, a block diagram of EIDS 200 communicably coupled to internal bus 312 of a building device is shown, according to some embodiments. In some such embodiments, EIDS 200 may be integrated into a host device's SoC. As shown, for example, a SoC 400 includes EIDS 200. SoC 400 is also shown to include a processing circuit 420 and an internal I/O 430. Processing circuit 420 and/or internal I/O 430 are generally the same as, or functionally equivalent to, processing circuit 320 and/or internal I/O 330, described above with reference to FIG. 3.

As shown, SoC 400 may be communicably coupled to internal bus 312. In some embodiments, SoC 400 is communicably coupled to internal bus 312 via internal I/O 430. In some embodiments, EIDS 200 is configured to monitor data traffic on internal bus 312. As described above, EIDS 200 may monitor data traffic on internal bus 312 to generate a traffic profile and/or detect cyberattacks (e.g., directed to SoC 400). In response to a cyberattack, EIDS 200 may also transmit data on internal bus 312, and thereby external bus 310, to alert a user of the cyberattack and/or to disable operations of SoC 400. Unlike the configuration shown in FIG. 3, however, integrating EIDS 200 with SoC 400 may also allow EIDS 200 to communicate directly with processing circuit 420. For example, EIDS 200 may transmit data directly to processing circuit 420 to disable operations of SoC 400. In another example, EIDS 200 may monitor data from processing circuit 420 directly, thereby identifying cyberattacks before they are transmitted via internal bus 312 or external bus 310.

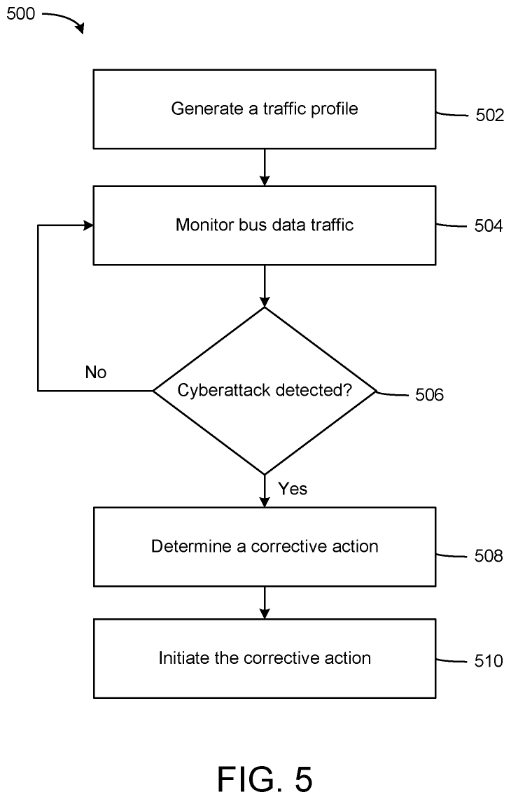

Referring now to FIG. 5, a flow diagram illustrating a process 500 for detection and response to cyberattacks on a building device (e.g., an IoT enable device) is shown, according to some embodiments. In general, data traffic (i.e., signal traffic) on buses (e.g., address, data, and control buses) of a host device is, to a large extent, repeatable and predictable between multiple boot sequences of the host device, assuming a common firmware version. In this respect, the patterns of data traffic tend to be predictable while the host device is operating. A change in, or absence of, known traffic patterns may indicate that the host device has been compromised due to a cyberattack. A system that performs process 500 (e.g., EIDS 200) may monitor such data traffic to detect and respond to cyberattacks. In various embodiments, process 500 is performed by an EIDS (e.g., EIDS 200) after being connected to an internal or external bus of a host device, or following an initialization (i.e., start-up) of the host device.

At step 502, a traffic profile is generated. The traffic profile may indicate known trustworthy or safe data patterns for a host device (e.g., a communication bus of the host device). In some embodiments, the traffic profile is generated using machine learning. In such embodiments, known good traffic data may be applied to a model of the host device or to a machine learning algorithm to generate the traffic profile. In some embodiments, the traffic profile is dynamically updated or regenerated over time, as the host device operates. As an example, a new I/O device could be added to the host device which may affect the data traffic patterns of the host device. In this case, profile generator 224 may dynamically update the traffic profile as it monitors data traffic with the new I/O device.

In some embodiments, the traffic profile may be generated based on a model of a host device and/or based on simulations of data traffic on communication buses of the host device. For example, the host device could be connected to a known-good segmented network and EIDS 200 may be allowed to monitor known-good data traffic for a period of time (e.g., 1-to-2 weeks) to generate the traffic profile. In such embodiments, the traffic profile may be uploaded to EIDS 200 during manufacture (e.g., the traffic profile is predetermined) or may by uploaded via a network or internet connection during installation, initialization, or operations of the host device.

In other embodiments, the traffic profile is generated by analyzing bus data traffic of the host device during operations and identifying patterns in the analyzed data. For example, EIDS 200 may monitor data traffic on external bus 310 and/or internal bus 312 and generate a traffic profile based on the monitored data traffic. In such embodiments, bus data traffic may be analyzed during an initialization period (e.g., after powering-on the host device) to generate a traffic profile during a period of known good data traffic. The traffic profile may be generated during a secure boot process, for example. As another example, EIDS 200 may monitor data traffic for 10 seconds after initializing the host device, when the data traffic is known or is highly likely to be good.

In some embodiments, a traffic profile may be generated or predefined based on known malicious data traffic patterns. For example, one or more traffic profiles for known malicious data traffic patterns (e.g., known malware or attack signatures) may be received from an external source (e.g., a user device, a network, etc.), such as during initialization of the host device or during operations of the host device. As in a previous example, known malicious traffic patterns may be uploaded to EIDS 200 during manufacture, at initialization, or while the host device is running. The known malicious traffic patterns may be received via a network (e.g., network 120) or internet connection from an external device (e.g., user device 130, a server or database, a remote security service, etc.), for example. In each of the embodiments described above, the traffic profile(s) may be stored in a database (e.g., database 132 or EIDS database 228) to be referenced by an intrusion detection system (e.g., EIDS 200).

At step 504, the bus is monitored and bus data traffic is continuously analyzed. In some embodiments, such as when the EIDS (e.g., EIDS 200) is preprogrammed with a traffic profile(s), the bus is monitored upon initialization of the host device (e.g., immediately after powering on). In other embodiments, where the traffic profile is generated or received as described in the previous step, the bus data traffic is monitored after the traffic profile is generated or received. In some embodiments, such as when using any of the detection methods described below, the bus data traffic may be analyzed by comparing the data traffic to the traffic profile.

Bus data traffic is generally dependent on the host device and an application of the host device. Therefore, bus data traffic patterns may have many different formats. In one example for a boot process, a typical traffic pattern may include loading software into a memory (e.g., of the host device). In this example, an EIDS may watch for modified (i.e., atypical) software or files other than expected software to be loaded. In another example, where the host device is a camera (e.g., or includes a camera), the host device may seldom utilize its CPU or RAM. Therefore, continuously high traffic on a communication bus utilized by the CPU and/or RAM may indicate a cyberattack.

In some embodiments, the bus data traffic may be monitored and analyzed using signature-based detection methods. Generally, signature-based detection is a method where an identifier (i.e., a signature, a profile, data traffic patterns) for a known threat (i.e., cyberattack) is identified, and data traffic is compared to the identifier (i.e., the known malicious data traffic signature). In some embodiments, the identifier is used to generate a traffic profile for the threat at step 502. In an example, EIDS 200 may compare the monitored data traffic to a plurality of known harmful or malicious traffic patterns or profiles (i.e., identifiers). A match between the data traffic and the harmful identifier may indicate a cyberattack. In various embodiments, the match between the bus data traffic and the harmful identifier may be an exact match or a match to within a threshold. Matching the bus data traffic to the harmful identifier according to a threshold may be desirable, as there may be glitches (i.e., outliers) or small changes to the bus data traffic, particularly when watching low-level signals.

In some embodiments, the bus data traffic may be monitored and analyzed using anomaly-based detection methods. In anomaly-based detection methods, data traffic on a bus is compared to a generated traffic profile or a normal data pattern for the bus. In some embodiments, the data traffic is compared to the traffic profiles generated at step 502. Data traffic may be considered anomalous if it falls outside of normal operations, indicated by a mismatch between in the monitored data traffic and a known trustworthy traffic profile. In such embodiments, a mismatch or difference between the bus data traffic and the traffic profile may be identified when the bus data traffic falls outside of a threshold. As described above, analyzing the data traffic according to a threshold may be desirable, as there may be glitches (i.e., outliers) or small changes to the bus data traffic, particularly when watching low-level signals.

In some embodiments, data traffic may also be considered anomalous based on an absence of expected data traffic, determined by the traffic profile. For example, EIDS 200 may compare monitored data traffic to plurality of generated or known trustworthy traffic profiles or patterns, where a change or absence of data traffic when compared to the traffic profiles may indicate a cyberattack. In various other embodiments, the bus data traffic may be monitored and analyzed using a combination of signature-based and anomaly-based detection methods, or by any other suitable detection method or combination of detection methods. As an example, a supervised machine learning algorithm may be used as a detection method. In this example, the supervised machine learning algorithm may dynamically generate traffic profiles (i.e., learn typical data traffic patterns) and monitor the bus data traffic to identify threats or attacks.

In some embodiments, the bus data traffic may be analyzed at regular time intervals (e.g., every 10 seconds). In such embodiments, the time interval may be predetermined, set by a user, or determined based on the traffic profile. For example, if the traffic profile was determined based on 30 seconds of traffic data, the bus data traffic may be analyzed every 30 seconds. In other embodiments, an EIDS (e.g., EIDS 200) could analyze the bus data traffic for triggering events. For example, the EIDS could analyze bus data traffic as connections are made (e.g., an I/O device is connected) or when functions or programs of the host device initiate. In such embodiments, the bus data traffic may be monitored for a period of time after the trigger event, to ensure that the operations (i.e., program or function) are performed according to the traffic profile. In some embodiments, based on an indication that there is no cyberattack detected at step 506, process 500 may continue by repeating step 504. In this manner, data traffic on the bus is continually monitored for malicious activity.

If a cyberattack is detected, process 500 may continue to step 508. At step 508, a corrective action is determined in response to the detected attack. The corrective action may include automated alerts or automated control actions that may be implemented to protect the host device being attacked, or to prevent other devices (e.g., other IoT devices) connected to the same network as the affected device from also being attacked. In some embodiments, the corrective action is determined based on the identified or detected threat. For example, an EIDS may determine a corrective action based on a predetermined policy for a set of known threats. In some embodiments, the corrective action may be determined based on a severity of the attack or based on a priority or importance level of the attacked device. As another example, certain IoT devices may be deemed more important than others, where more aggressive corrective actions may be taken to protect important or sensitive host devices.

In some embodiments, the determined corrective action includes notifying a user (e.g., a system administrator, a manager, etc.) to the detected threat. The notification may alert the user to the cyberattack and may provide the user with additional information. For example, the notification may include information about the detected attack such as a detection time, an identification of the type of attack, an indication of the response to the attack, or other information about the attack. Based on the notification and/or the information about the attack, the user may take further corrective actions. For example, the user may dispatch maintenance or service personnel, disconnect or shut off the affect host device, run antimalware or antivirus software, reboot or reset the device, or any other type of additional corrective action.

In some embodiments, the determined corrective action includes automated control actions, such as disrupting operations of the host device. Operations of the host device may be interrupted in a number of ways. In various embodiments, an automated control action may include resetting the host device, turning the host device off, disconnecting the host device from a network, jamming a communications bus of the host device, or any other suitable control action. In such embodiments, the automated control action may include a control command, a signal, or other data that may be transmitted (e.g., at step 510) to the host device's SoC or implemented by the EIDS and/or transmitted via a communication bus.

At step 510, the corrective action is initiated. In some embodiments, initiating the corrective action includes generating and/or transmitting a notification to a user device (e.g., user device 130). The notification may include an alert and/or a report based on a detected threat. As described above with respect to FIG. 2, for example, the alert may be an indication of the threat or attack that contains a limited amount of information related to the detected threat, whereas the report may be a more in-depth indicator of the threat that includes more information that the alert. The alert or report may include an indication of the host device being attacked (e.g., a device name, a device address, etc.), an indication of the type of attack, or any other information that may aid a user in determining follow up actions in response to the attack.

In some embodiments, the alert or report is transmitted to the user device (e.g., via a network or internet connection) as a notification, an email, a text message, an automated phone call, or by any other method. For example, responsive to a determination that the corrective action includes generating an alert (e.g., at step 508), an EIDS may generate an automated text message and subsequently transmit the text message to a user's mobile device. In some embodiments, automatically transmitting an alert or message may further include retrieving contact information for a user or administrator from a database (e.g., database 132). In some embodiments, the alert and/or report are also transmitted to a database (e.g., database 132) for storage. Stored (i.e., historical) information may help a user increase future cybersecurity efforts and/or monitor building devices to more effectively manage a facility.

In some embodiments, initiating the corrective action includes disrupting the operations of the host device. In one example, disrupting the operations includes halting the execution of a host device's firmware by transmitting a reset signal that causes the host device to reset. The reset signal may safeguard the host device by interrupting the execution of the host device's firmware and rebooting the host device. In another example, an EIDS may halt the execution of the host device's firmware by transmitting a random data sequence. The random data sequence may jam the bus, preventing additional data from being transmitted. For example, the random data sequence may prevent the host device data from being retrieved by the cyber-attacker and/or may prevent additional data from being transmitted by the cyber-attacker to the host device. The random data sequence may also act to overwhelm the host device's SoC and/or CPU, which may not have the ability to react to a large, random string of data.

In various embodiments, the reset signal or random data sequence may be transmitted via the bus or may be transmitted directly to a processing circuit (e.g., processor, CPU) of the host device's SoC. In other embodiments, another method may be utilized to halt the execution of the host device's firmware in response to a cyberattack. For example, as described above, an EIDS may disconnect the host device from a network or internet connection. In another example, the EIDS may run antimalware software on the host device to eliminate the attack or threat.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A device with embedded intrusion detection, the device comprising:
a housing;
a first processing circuit configured to perform one or more functions;
a communication path configured to communicate data between the first processing circuit and one or more other components; and
a second processing circuit, the first processing circuit and the second processing circuit contained within the housing, the second processing circuit configured to:
monitor the data transmitted on the communication path;
determine whether the device is in a compromised state based on the monitored data; and
initiate a corrective action responsive to a determination that the device is in the compromised state.

2. The device of claim 1, wherein the corrective action comprises:
generating a notification comprising information associated with the determination that the device is in the compromised state; and
transmitting, to a user device via a network connection, the notification.

3. The device of claim 1, wherein the corrective action comprises at least one of:
transmitting, via the communication path, a reset signal to the first processing circuit; or
transmitting, via the communication path, random data to the first processing circuit.

4. The device of claim 1, the second processing circuit configured to:
identify a traffic pattern for the communication path, wherein the traffic pattern is a pattern of the data transmitted on the communication path; and
generate a first traffic profile for the device based on the traffic pattern.

5. The device of claim 4, the second processing circuit configured to receive a second traffic profile based on previously identified patterns of data associated with known malicious data.

6. The device of claim 5, the second processing circuit configured to determine that the device is in the compromised state by:
determining that the monitored data does not match the first traffic profile for the device; or
determining that the monitored data is outside of a threshold of the second traffic profile.

7. A circuit for detecting whether a building device is in a compromised state, the circuit structured to be mounted within a housing of the building device, the building device comprising a processor and a communication path configured to communicate data between the processor and one or more other components of the building device, the circuit comprising:
an interface configured to receive data transmitted on the processor communication path; and
processing circuitry configured to:
analyze the received data to determine whether the building device is in the compromised state; and
initiate a corrective action responsive to a determination that the building device is in the compromised state.

8. The circuit of claim 7, wherein the communication path is at least one of an address bus, a data bus, or a control bus.

9. The circuit of claim 7, the processing circuitry further configured to:
identify a traffic pattern for the communication path, wherein the traffic pattern is a pattern of the data transmitted on the communication path; and
generate a first traffic profile for the building device based on the traffic pattern.

10. The circuit of claim 9, the processing circuit further configured to receive, from a user device, a second traffic profile based on previously identified patterns of data associated with known malicious data.

11. The circuit of claim 10, wherein a determination that the building device is in the compromised state is based on:
an indication that the received data does not match the first traffic profile for the building device; or
an indication that the received data is outside of a threshold of the second traffic profile.

12. The circuit of claim 7, wherein initiating the corrective action comprises at least one of:
transmitting, via the communication path, a reset signal to the processor of the building device; or
transmitting, via the communication path, random data to the processor of the building device.

13. The circuit of claim 7, the processing circuitry further configured to:
generate, based on a determination that the building device is in the compromised state, at least one of an alert or a report, the report comprising information associated with the determination that the building device is in the compromised state; and
transmit, to a user device via a network connection, at least one of the alert or the report.

14. A system comprising:
a building device comprising:
a housing;
a processor configured to perform one or more functions; and
a communication path configured to communicate data between the processor and one or more other components of the building, wherein the processor and the communication path are contained within the housing; and
a circuit comprising:
an interface configured to receive data transmitted on the communication path; and
processing circuitry configured to analyze the received data to determine whether the building device is in a compromised state.

15. The system of claim 14, the processing circuitry further configured to:
identify a traffic pattern for the communication path, wherein the traffic pattern is a pattern of the data transmitted on the communication path; and
generate a traffic profile for the building device based on the traffic pattern.

16. The system of claim 15, the processing circuit further configured to receive, from a user device, a second traffic profile based on previously identified patterns of data associated with known malicious data.

17. The system of claim 16, wherein a determination that the building device is in the compromised state is based on:
an indication that the received data does not match the first traffic profile for the building device; or
an indication that the received data matches the second traffic profile.

18. The system of claim 14, the processing circuitry further configured to initiate a corrective action, wherein the corrective action comprises at least one of:
transmitting, via the communication path, a reset signal to the processor of the building device; or
transmitting, via the communication path, random data to the processor of the building device.

19. The system of claim 14, the processing circuitry further configured to:
generate, based on a determination that the building device is in the compromised state, at least one of an alert or a report, the report comprising data associated with the determination that the building device is in the compromised state; and
transmit, to a user device via a network connection, at least one of the alert or the report.

20. The system of claim 14, wherein the communication path is at least one of an address bus, a data bus, or a control bus.
